(19) United States
(12) Patent Application Publication
(10) Pub. No.: US 2012/0305674 A1
(43) Pub. Date: Dec. 6, 2012

(54) FUEL INJECTOR

(76) Inventors: Martin Buehner, Becknang (DE); Marco Vorbach, Freiberg (DE); Jens Koenig, Markgroeningen (DE); Birgit Woehlert, Bursa (TR)

(21) Appl. No.: 13/514,806

(22) PCT Filed: Oct. 27, 2010
(86) PCT No.: PCT/EP2010/066262

§ 371 Date: Aug. 24, 2012

(30) Foreign Application Priority Data
Dec. 9, 2009 (DE) 10 2009 047 704.7

(51) Int. Cl. F02M 61/00; B21D 51/16

(52) U.S. Cl. 239/533.2; 29/890.09

(57) ABSTRACT

A fuel injector is described having a multi-orifice nozzle provided with a multitude of spray orifices through which fuel is injected, the multi-orifice nozzle having at least two spray orifices that have different spray-orifice diameters. Furthermore, a method is described for producing, by laser drilling, a multi-orifice nozzle having a multitude of spray orifices, at least two spray orifices having different spray orifice diameters.

### FIELD OF THE INVENTION

The present invention relates to a fuel injector for internal combustion engines having direct Diesel or gasoline injection, the injector having a multi-orifice nozzle; it also relates to a method for producing a multi-orifice nozzle.

### BACKGROUND INFORMATION

In conventional fuel injectors having multi-orifice nozzles, the spray orifices are produced through spark erosion processes. The electrode diameter is specified in this process, so that it is impossible to vary the individual spray orifice diameters in the multi-orifice nozzle. As a result, the fuel quantity emerging from each spray orifice and its jet length are always identical in size and not adjustable to different combustion chamber shapes.

### SUMMARY

An example fuel injector according to the present invention may have the advantage of providing a fuel injector which has a multi-orifice nozzle provided with a multitude of spray orifices through which the fuel is injected, the multi-orifice nozzle having at least two spray orifices whose diameters are of different size. This makes it possible to divide the injected fuel mass flow into individual jets having different submasses and to inject them into the combustion chamber with improved distribution and precision.

According to one preferred development of the present invention, all spray-orifice diameters differ. This makes it possible to optimally distribute the injected fuel quantity via different jet lengths and to adapt it to different combustion chamber shapes and engine-load ranges, individually for each orifice. Due to the adapted individual jets, wall wetting of the cylinder and/or washing-off of the oil film situated thereon are prevented, as is worsening of the exhaust-gas emissions resulting therefrom.

Starting from the largest spray-orifice diameter, a diameter of an adjacent spray orifice preferably becomes increasingly smaller. With the aid of the resulting, consecutively reduced lengths and submasses of the individual jets, an individually preferred directional and mass distribution of the injected fuel spray is able to be achieved.

Furthermore, the center points of the spray orifices are preferably situated on a circle. In addition, all center points on an exit side of the spray orifices are preferably situated in a common plane. This approach allows an accurate production of the fuel injector with precisely aligned and dimensioned spray-orifice diameters at low cost per item and in a simple manner.

According to one preferred development of the present invention, center axes of the spray orifices are situated at an acute angle, especially at different acute angles, relative to a valve center axis. This makes it possible to generate and inject a fuel spray that is optimally distributed three-dimensionally also in direction of the longitudinal injector axis.

Diameter D of the spray orifices preferably lies between 30 μm ≦D≦300 μm. In conjunction with the number of spray orifices, this results in a considerably improved charge of the combustion chamber and the ignitable mixture situated therein. The large dimensional range between minimum and maximum diameter provides the possibility of large variation differences between the individual jet lengths or injected fuel submasses of the fuel injector. As a consequence, a virtually ideal spray distribution is able to be achieved inside the combustion chamber.

It is furthermore preferred if the spray orifices are produced by laser drilling, in particular ultra short pulse (USP) laser drilling. Thus, spray orifices having highly accurate individual orifice diameters or orifice cross-sections within a nozzle or a valve seat are able to be produced.

In an especially preferred manner, each spray orifice of the multi-orifice nozzle generates an individual spray cone, the spray cones preferably being produced in such a way that no overlapping spray cones are formed.

Furthermore, the present invention relates to a method for producing, by laser drilling, a multi-orifice nozzle provided with a multitude of spray orifices, at least two spray orifices being produced which have different spray orifice diameters. Due to this manufacturing method, spray orifices that have shapes and cross-sections, such as tapers, trumpet shapes, bottle shapes, as well as rectangular, triangular, slot-shaped, circular or oval cross-sections are able to be produced independently of each other. Moreover, the manufacturing method allows the production of fuel injectors at no extra expense at generally identical machining times.

### BRIEF DESCRIPTION OF THE DRAWINGS

An exemplary embodiment of the present invention is described in detail below, with reference to the figures.

FIG. 1 shows an enlarged schematic illustration of an example multi-orifice nozzle of a fuel injector according to the present invention.

FIG. 2 shows an enlarged sectional view of a sub-region of the multi-orifice nozzle.

FIG. 3 shows an enlarged, perspective illustration of the individual jets emerging from the fuel injector.

### DETAILED DESCRIPTION OF EXAMPLE EMBODIMENTS

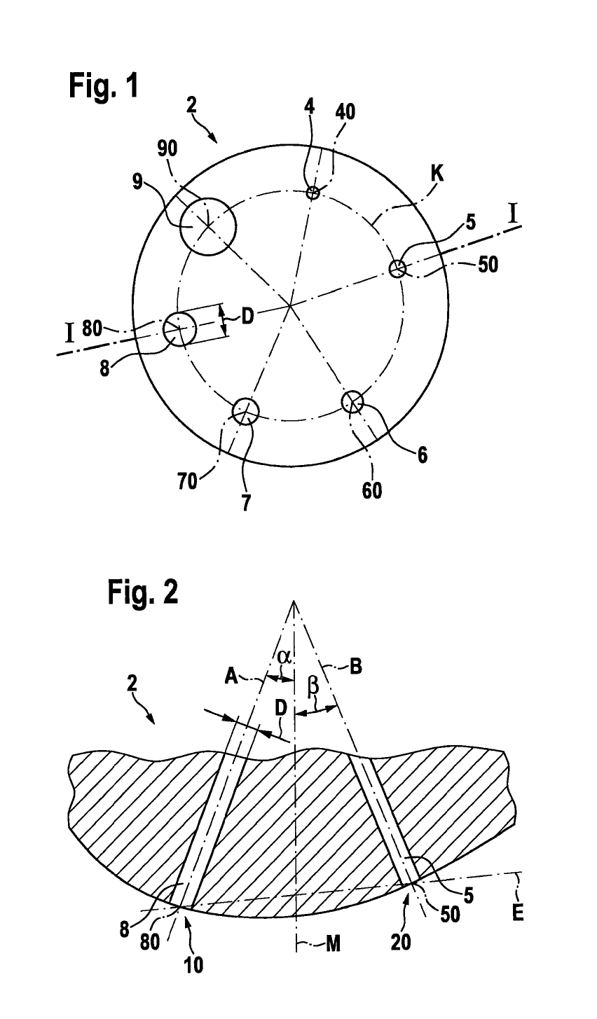

Below, a fuel injector for the injection of fuel according to one preferred exemplary embodiment of the present invention, and a method for producing a multi-orifice nozzle of the fuel injector are described in detail with reference to FIGS. 1 to 3.

A multi-orifice nozzle 2, shown in FIG. 1, of fuel injector 1 according to an example embodiment of the present invention has a multitude of spray orifices 4, 5, 6, 7, 8 and 9, whose respective center points 40, 50, 60, 70, 80 and 90 are disposed on a concentric circle K at identical angular distances. As can furthermore be gathered from FIG. 1, spray orifices 4, 5, 6, 7, 8 and 9 all have a different spray-orifice diameter D, which is indicated for spray orifice 8 by way of example. Starting from the largest spray orifice diameter of spray orifice 9, the spray orifice situated adjacently in a counter-clockwise direction has a smaller spray orifice diameter. For the sake of simplicity, the exit cross-sections of spray orifices 4, 5, 6, 7, 8 and 9 are shown as circle cross-sections in FIG. 1. In this context it should be mentioned that the exit cross-sections of spray orifices 4, 5, 6, 7, 8 and 9 may also have any other cross-section and shape, independently of each other.

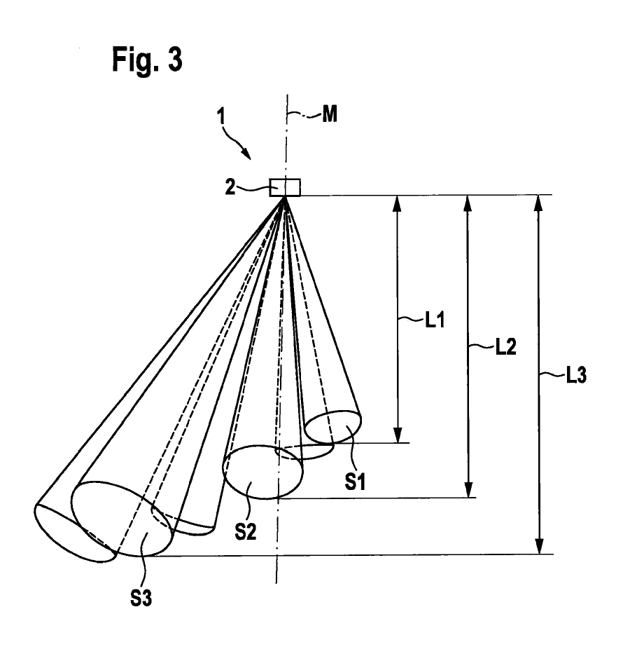

As can be gathered from the enlarged sectional view shown in FIG. 2 in a line I-I of FIG. 1, visible center points 50, 80 of spray orifices 5 and 8 on an exit side, and all other not visible center points 40, 60, 70, 90 of spray orifices 4, 6, 7, 9 lie in a common plane E. An axis A extending through center point 80 of an exit side 10 of spray orifice 8 is inclined at an acute angle α relative to a valve center axis M, and an axis B extending through center point 50 of an exit side 20 of spray orifice 5 is inclined at an acute angle β relative to axis M. Due to the different diameters of spray orifices 5 and 8 and their different angles of inclination α and β, respectively, in relation to valve center axis M, it is possible to inject partial fuel mass flows of different sizes into preferred regions of the combustion chamber. Since the diameters of the spray orifices differ, different jet lengths of the injected fuel result in addition, as schematically illustrated in FIG. 3 with the aid of three individual jets S1, S2 and S3.

As can be gathered from FIG. 3, jet S1, which is injected from spray orifice 4 having the smallest diameter, has a jet length L1, while jet S2 from spray orifice 6 having a medium diameter has a medium jet length L2, and jet S3 from spray orifice 9 having the largest diameter has a large jet length L3. The perspective illustration in FIG. 3 clearly illustrates the three-dimensional alignment of the individual jets in relation to valve center axis M and the resulting targeted spatial distribution of the fuel spray brought about by the different exit cross-sections of the individual orifices.

As shown in FIG. 3, a separate spray cone is produced by each spray orifice, so that an individual, three-dimensional spray pattern comes about. Each spray cone is preferably formed by a different fuel quantity, and the spray is able to be adapted to the individual combustion chamber geometry in optimal manner by varying the spray orifices. The spray cones shown in FIG. 3 have the same gradient, but it is also possible for the spray cones to have different gradients. The spray cones preferably do not merge, so that air-filled gaps remain between the spray cones.

In the production of multi-orifice nozzle 2 by ultra short pulse (USP) laser drilling, the multitude of spray orifices 40, 50, 60, 70, 80 and 90 is produced with different spray orifice diameters and possibly different angles of inclination relative to valve center axis M. This allows the production of random cross-sections, shapes and alignment angles, at machining times and costs that are comparable to conventional nozzles.

Using the example fuel injector according to the present invention and the example production method of the multi-orifice nozzle of the fuel injector according to the present invention, the rapid mixture ignition required in combustion engines having direct Diesel or gasoline injection and the complete combustion of the injected fuel spray in the combustion engine, are able to be increased considerably due to the jets which are adjustable in a three-dimensionally defined manner for each orifice individually. The larger a cross-section of a spray orifice, the longer the spray-discharged jet, and the larger the partial fuel quantity spray-discharged from this spray orifice. In addition to potential fuel savings, this also contributes to a further reduction in emissions.

1-10. (canceled)

11. A fuel injector including a multi-orifice nozzle having a multitude of spray orifices through which fuel is spray-discharged, the multi-orifice nozzle having at least two spray orifices with different spray-orifice diameters relative to one another.

12. The fuel injector as recited in claim 11, wherein all of the spray-orifices have different spray-orifice diameters relative to each other.

13. The fuel injector as recited in claim 11, wherein starting from a largest one of the spray orifices, a diameter of an adjacent spray orifice becomes increasingly smaller.

14. The fuel injector as recited in claim 11, wherein center points of the spray orifices are disposed on a circle.

15. The fuel injector as recited in claim 14, wherein all of the center points on an outlet side of the spray orifices lie in a common plane.

16. The fuel injector as recited in claim 14, wherein center axes of the spray orifices are situated at an acute angle, in particular at different acute angles relative to a valve center axis.

17. The fuel injector as recited in claim 11, wherein a diameter D of the spray orifices is between 30 μm≦D≦300 μm.

18. The fuel injector as recited in claim 11, wherein the spray orifices are produced by ultra short pulse laser drilling.

19. The fuel injector as recited in claim 11, wherein the multi-orifice nozzle produces a separate spray cone for each of the spray orifices, and each spray cone is individual.

20. A method for producing a multi-orifice nozzle having a multitude of spray orifices, comprising:
pulse drilling to produce at least two spray orifices having different spray-orifice diameters.
